(19) United States
(12) Patent Application Publication
(10) Pub. No.: US 2018/0342197 A1
(43) Pub. Date: Nov. 29, 2018

(54) PIXEL CIRCUIT, DRIVING METHOD THEREOF AND DISPLAY USING THE SAME

(71) Applicant: EverDisplay Optronics (Shanghai) Limited, Shanghai (CN)

(72) Inventor: Xingyu ZHOU, Shanghai (CN)

(73) Assignee: EverDisplay Optronics (Shanghai) Limited, Shanghai (CN)

(21) Appl. No.: 15/984,722

(22) Filed: May 21, 2018

(30) Foreign Application Priority Data
May 23, 2017 (CN) 201710369279.4

(51) Int. Cl. G09G 3/32

(52) U.S. Cl. CPC G09G 3/32; G09G 2330/021; G09G 2310/0278; G09G 2310/0243

(57) ABSTRACT

A pixel circuit, a driving method thereof and a display are disclosed. In a compensation unit, a first electrode of a switching transistor is connected to a gate electrode of a compensation transistor, a second electrode of the switching transistor is connected to a first electrode of the compensation transistor; the gate electrode of the compensation transistor is connected to a driving unit through a first node, a second electrode of the compensation transistor is connected to a data signal; the compensation unit sets a voltage of the first node to be a first voltage; the capacitor is configured to keep the voltage of the first node to be the first voltage; the driving unit is configured to generate a driving current to drive the light emitting unit to emit light; and a driving transistor in the driving unit and the compensation transistor are a common-gate transistor.

### CROSS REFERENCE TO RELATED APPLICATIONS

The present application is based upon and claims priority to Chinese Patent Application No. 201710369279.4, filed on May 23, 2017, the entire contents of which are incorporated herein by reference.

### TECHNICAL FIELD

The present invention relates to the field of electronic display technology, and more particular, to a pixel circuit, a driving method thereof and a display using the same.

### BACKGROUND

In a conventional pixel circuit, generally, a light emitting diode in the pixel circuit is driven to emit light by a thin film transistor, which is called a driving transistor. The driving transistor operates in a saturation state, it is because that in the saturation state, a driving current outputted from the driving transistor is less sensitive to a source-drain voltage than the driving transistor in a linear state, which can supply a more stable driving current for the light emitting diode. FIG. 1 shows the most basic pixel circuit of the prior art. As shown in FIG. 1, the pixel circuit is composed of two transistors T11 and T12 and one capacitor C11. When a signal Sn controls the transistor T12 to be turned on, a data signal data is written into a node N1 to charge the capacitor C11, and at the same time, the driving transistor T11 is turned on. A driving current generated by the transistor T11 enables a light emitting diode EL11 disposed between a first power supply ELVDD and a second power supply ELVSS to emit light. A driving current I_{EL} is shown in Formula 1.

$${I}_{EL} = \frac{1}{2} μ {C}_{OX} \frac{W}{L} {( {V}_{GS} + {V}_{TH} )}^{2} \qquad ( Formula 1 )$$

Where μ is a carrier mobility, C_{OX} is a gate oxide unit-area capacitance of the transistor T11, L is a channel length of the transistor T11, W is a gate width of the transistor T11, V_{GS} is a gate-source voltage of the transistor T11, and V_{TH} is a threshold voltage of the transistor T11. From Formula 1, it can be seen that amplitude of the driving current is related to the threshold voltage of the transistor T11. However, due to the existence of threshold drift phenomenon, the threshold voltage of the driving transistor T11 is not stable, causing the drift of the driving current, and making brightness of the light emitting diode uneven.

In order to solve the above-described problems, designers have studied a series of circuits that can eliminate the influence of threshold drift of the driving transistor, which can be called threshold compensation circuits. FIG. 2 shows a conventional threshold compensation circuit. As shown in FIG. 2, in a data writing stage, a signal Sn turns on transistors T22 and T23 to short-circuit a gate electrode and a drain electrode of a driving transistor T21, at the same time, a signal En turns off a transistor T25, a signal Sn−1 turns off a transistor T24, and a data signal data is inputted to a source electrode of T21 via T22. Because the gate electrode and the drain electrode of T21 are short-circuited at this time, the data signal is transmitted to the gate electrode via the drain electrode of T21, and a capacitor C21 starts to store charges such that after a voltage of a gate electrode of T22 is gradually decreased to (V_{data}+V_{TH}), T21 enters an off-state, and the charging of C21 is stopped. In a light emitting stage, the signal En controls the transistor T25 to be turned on, the signal Sn−1 turns off the transistor T24, the signal Sn turns off the transistors T22 and T23, and a power supply ELVDD is transmitted to the driving transistor T21 through the transistor T25. At this time, the driving transistor generates a driving current as shown in Formula 2.

$${I}_{EL} = \frac{1}{2} μ {C}_{OX} \frac{W}{L} {( {V}_{ELVDD} + {V}_{data} )}^{2} \qquad ( Formula 2 )$$

From Formula 2, it can be seen that amplitude of the driving current is no longer related to a threshold voltage of the driving transistor T21.

However, in the conventional threshold compensation circuit represented by FIG. 2, during the data writing stage, only the transistor T25 is interposed between the power supply ELVDD and the data signal. Because a voltage of the power supply ELVDD is much greater than voltages of other signals, and because of a leakage current of the T25, the data signal is extremely affected by the power supply ELVDD, thereby affecting light emitting stability of a light emitting diode. In addition, the circuit is composed of a plurality of transistors, thus has a complicated structure and high costs.

In summary, there is a problem in the prior art that the light emitting diode is unstable in light emitting and has a complicated structure.

### SUMMARY

The present invention provides a pixel circuit, a driving method, and a display using the same, which are used to solve at least a part of the problem that a light emitting diode fails to emit light stably and has a complicated structure in a conventional pixel circuit.

An embodiment of the present invention provides a pixel circuit including a compensation unit, a driving unit, a light emitting unit, a capacitor and an external power supply, wherein the compensation unit includes a compensation transistor and a switching transistor;

in the compensation unit, a gate electrode of the switching transistor is connected to a first scanning signal, a first electrode of the switching transistor is electrically connected to a gate electrode of the compensation transistor, and a second electrode of the switching transistor is electrically connected to a first electrode of the compensation transistor; the gate electrode of the compensation transistor is electrically connected to the driving unit through a first node, and a second electrode of the compensation transistor is connected to a data signal; the external power supply, the driving unit, and the light emitting unit are connected in series in sequence; and the capacitor is disposed between the first node and the external power supply;

the compensation unit is configured to turn on the switching transistor under the control of the first scanning signal, so that the compensation transistor sets a voltage of the first node to be a first voltage, wherein the first voltage is a voltage obtained by compensating a voltage of the data signal by the compensation transistor;

the capacitor is configured to keep the voltage of the first node to be the first voltage;

a first control signal is inputted to the driving unit from the external, and the driving unit is configured to generate a driving current to drive a light emitting unit to emit light according to the first control signal, wherein the driving current is obtained based on the first voltage, the external power supply and a threshold voltage of a driving transistor in the driving unit; and the driving transistor and the compensation transistor are a common-gate transistor.

Optionally; the driving transistor and the compensation transistor are a mirror transistor.

Optionally, the compensation unit further includes a data strobe transistor;

wherein a first electrode of the data strobe transistor is electrically connected to the second electrode of the compensation transistor, a second electrode of the data strobe transistor is electrically connected to the data signal, and a gate electrode of the data strobe transistor is electrically connected to the first scanning signal; and the data strobe transistor is configured to connect the data signal to the compensation transistor under the effect of the first scanning signal.

Optionally, the pixel circuit further includes an initializing unit;

the initializing unit is disposed between the first node and the light emitting unit, and a second scanning signal and an initializing voltage are inputted to the initializing unit from the external;

the initializing unit is configured to initialize the first node and the light emitting unit with the initializing voltage under the control of the second scanning signal.

Optionally, the initializing unit includes a first initializing transistor and a second initializing transistor:

the initializing voltage is inputted to a first electrode of the first initializing transistor from the external, a second electrode of the first initializing transistor is electrically connected to the first node, and a gate electrode of the first initializing transistor is electrically connected to the second scanning signal;

the initializing voltage is inputted to a first electrode of the second initializing transistor from the external, a second electrode of the second initializing transistor is electrically connected to the light emitting unit, and a gate electrode of the second initializing transistor is electrically connected to the second scanning signal.

Optionally, the driving unit includes a driving transistor and a light emitting control transistor;

a first electrode of the light emitting control transistor is externally connected to a first power supply, a second electrode of the light emitting control transistor is electrically connected to a first electrode of the driving transistor, and the first control signal is inputted to a gate electrode of the light emitting control transistor from the external;

a gate electrode of the driving transistor is electrically connected to the compensation unit, and a second electrode of the driving transistor is electrically connected to the light emitting unit.

An embodiment of the present invention provides a method for driving a pixel circuit, applied to the above-described pixel circuit, the method including:

a data writing stage, in which the first scanning signal is controlled to turn on the switching transistor so that the compensation transistor sets a voltage of the first node to be the first voltage; the first control signal is controlled to turn off the driving unit, and the light emitting unit does not emit light; and the capacitor keeps the voltage of the first node to be the first voltage, wherein the first voltage is a voltage obtained by compensating a voltage of the data signal by the compensation transistor in the compensation unit;

a light emitting stage, the first scanning signal is controlled to turn off the switching transistor, the first control signal is controlled to turn on the driving unit, and the driving unit generates a driving current to drive the light emitting unit to emit light, wherein the driving current is obtained based on the first voltage, the external power supply and a threshold voltage of the driving transistor in the driving unit; and the capacitor is in a hold-state.

Optionally, the data writing stage further includes:

controlling the first scanning signal to turn on the data strobe transistor to input the data signal to the compensation transistor.

Optionally, before the data writing stage, the method further includes:

an initializing stage, in which the second scanning signal is controlled to turn on the initializing unit, which initializes the first node and the light emitting unit using the initializing voltage, the capacitor holds the initializing voltage, the first scanning signal is controlled to turn off the switching transistor, and the first control signal is controlled to turn off the driving unit.

Optionally, the data writing stage further includes controlling the second scanning signal to turn off the initializing unit.

The lighting emitting stage further includes controlling the second scanning signal to turn off the initializing unit.

An embodiment of the present invention provides a display including the above-described pixel circuit.

In summary, the embodiments of the present invention provide a pixel circuit, a driving method thereof, and a display using the same, and the pixel circuit includes a compensation unit, a driving unit, a light emitting unit, a capacitor and an external power supply, wherein the compensation unit includes a compensation transistor and a switching transistor; in the compensation unit, a gate electrode of the switching transistor is connected to a first scanning signal, a first electrode of the switching transistor is electrically connected to a gate electrode of the compensation transistor, and a second electrode of the switching transistor is electrically connected to a first electrode of the compensation transistor; the gate electrode of the compensation transistor is electrically connected to the driving unit through a first node, and a second electrode of the compensation transistor is connected to a data signal; the external power supply, the driving unit, and the light emitting unit are connected in series in sequence; the capacitor is disposed between the first node and the external power supply; the compensation unit is configured to turn on the switching transistor under the control of the first scanning signal, so that the compensation transistor sets a voltage of the first node to be a first voltage, wherein the first voltage is a voltage obtained by compensating a voltage of the data signal by the compensation transistor; the capacitor is configured to keep the voltage of the first node to be the first voltage; a first control signal is inputted to the driving unit from the external, and the driving unit is configured to generate a driving current to drive a light emitting unit to emit light according to the first control signal, wherein the driving current is obtained based on the first voltage, the external power supply and a threshold voltage of a driving transistor in the driving unit; and the driving transistor and the compensation transistor are a common-gate transistor. The data signal is inputted to the compensation unit from the external, and the driving unit is externally connected to the external power supply, so that in a data writing stage, the data signal is compensated by the compensation transistor in the compensation unit, and a threshold voltage of the compensation transistor compensates the voltage of the data signal to obtain the first voltage. Since the compensation unit is not externally connected to the external power supply, the influence of the external power supply on the data signal is avoided. Moreover, the driving transistor and the compensation transistor are a common-gate transistor, both of them having the same change trend of threshold voltage, so compensating the threshold voltage of the compensation transistor to the voltage of the data signal corresponds to compensating the threshold voltage of the driving transistor to the voltage of the data signal, which ensures a threshold compensation function of the pixel circuit. Therefore, the embodiments of the present invention can achieve the threshold compensation function of the pixel circuit while avoiding the influence of the external power supply on the data signal, thereby improving light-emitting stability of a light-emitting diode. In addition, the switching transistor in the compensation unit can not only control the turn-on and turn-off of the compensation unit, but also can indirectly control the input of the data signal, in this way, one transistor achieves functions of two transistors, thereby simplifying a circuit structure and reducing circuit costs.

### BRIEF DESCRIPTION OF THE DRAWINGS

In order to more clearly illustrate technical solutions in the embodiments of the present invention, the drawings used in the description of the embodiments are briefly described below. Obviously, the drawings in the following description are merely some embodiments of the present invention. Those skilled in the art can also obtain other drawings based on these drawings without any creative labor.

FIG. 1 shows the most basic pixel circuit in the prior art:

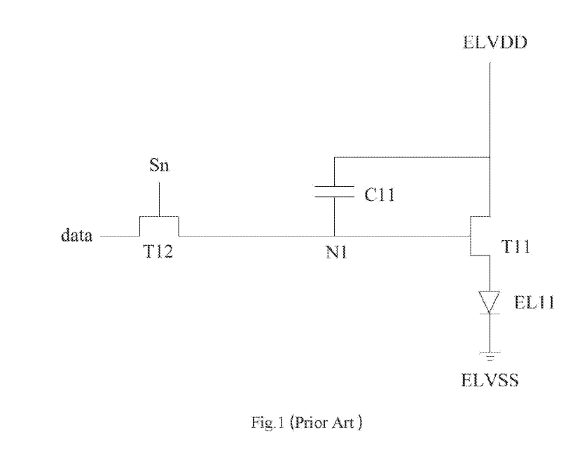

FIG. 2 shows a conventional threshold compensation circuit:

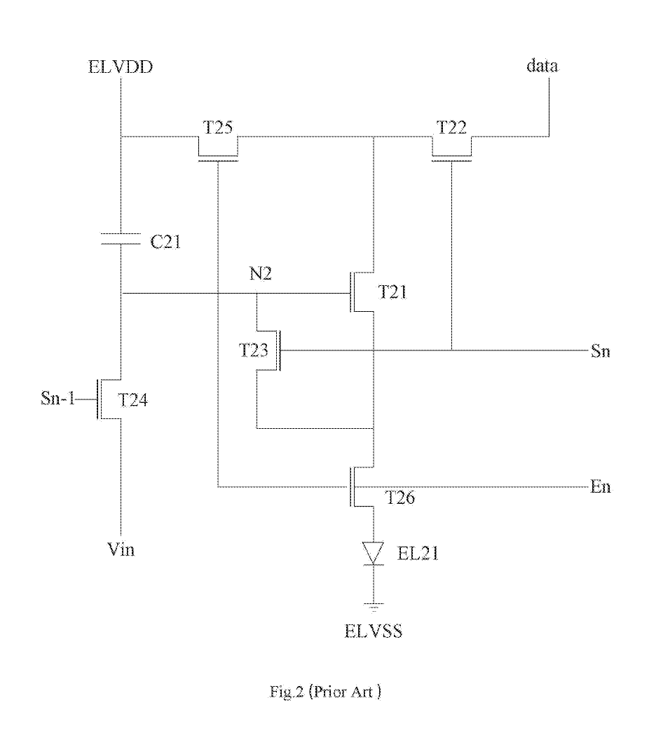

FIG. 3 is a schematic diagram of architecture of a pixel circuit according to an embodiment of the present invention;

FIG. 4 is a schematic diagram of another architecture of a pixel circuit according to an embodiment of the present invention:

FIG. 5 is a schematic diagram of architecture of a pixel circuit having an initializing function according to an embodiment of the present invention;

FIG. 6 is a structural schematic diagram illustrating an initializing unit according to an embodiment of the present invention;

FIG. 7 is a structural schematic diagram illustrating a driving unit according to an embodiment of the present invention:

FIG. 8 is a flowchart showing a method for driving a pixel circuit according to an embodiment of the present invention:

FIG. 9 is a schematic diagram illustrating a driving signal according to an embodiment of the present invention:

FIG. 10 is a schematic diagram illustrating a driving signal according to an embodiment of the present invention:

FIG. 11 is one of feasible implementation manners of a pixel circuit according to an embodiment of the present invention; and

FIG. 12 is a structural schematic diagram of a display according to an embodiment of the present invention.

### DETAILED DESCRIPTION

To make objectives, technical solutions, and advantages of the present invention clearer, hereinafter, the present invention will be further described in detail with reference to the accompanying drawings. Obviously, the described embodiments are merely some but not all of the embodiments of the present invention. All of the other embodiments obtained by a person of ordinary skill in the art based on the embodiments of the present invention without creative efforts shall fall within the protection scope of the present invention.

An embodiment of the present invention discloses a pixel circuit including a compensation unit, a driving unit, a light emitting unit, a capacitor, and an external power supply, wherein the compensation unit includes a compensation transistor and a switching transistor; in the compensation unit, a gate electrode of the switching transistor is connected to a first scanning signal, a first electrode of the switching transistor is electrically connected to a gate electrode of the compensation transistor, and a second electrode of the switching transistor is electrically connected to a first electrode of the compensation transistor; the gate electrode of the compensation transistor is electrically connected to the driving unit through a first node, and a second electrode of the compensation transistor is connected to a data signal; the external power supply, the driving unit, and the light emitting unit are connected in series in sequence; the capacitor is disposed between the first node and the external power supply; the compensation unit is configured to turn on the switching transistor under the control of the first scanning signal, so that the compensation transistor sets a voltage of the first node to be a first voltage, wherein the first voltage is a voltage obtained by compensating a voltage of the data signal by the compensation transistor; the capacitor is configured to keep the voltage of the first node to be the first voltage; a first control signal is inputted to the driving unit from the external, and the driving unit is configured to generate a driving current to drive a light emitting unit to emit light according to the first control signal, wherein the driving current is obtained based on the first voltage, the external power supply and a threshold voltage of a driving transistor in the driving unit; and the driving transistor and the compensation transistor are a common-gate transistor.

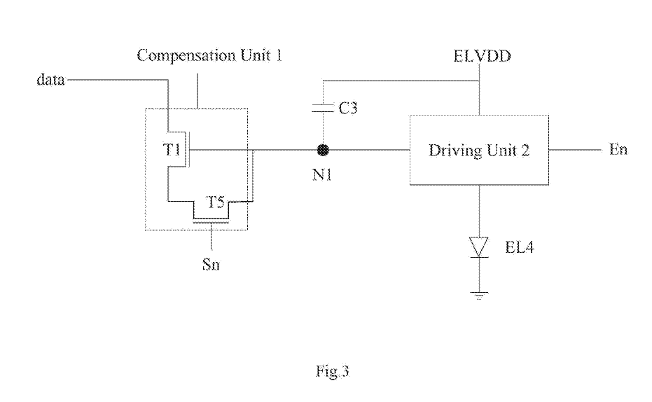

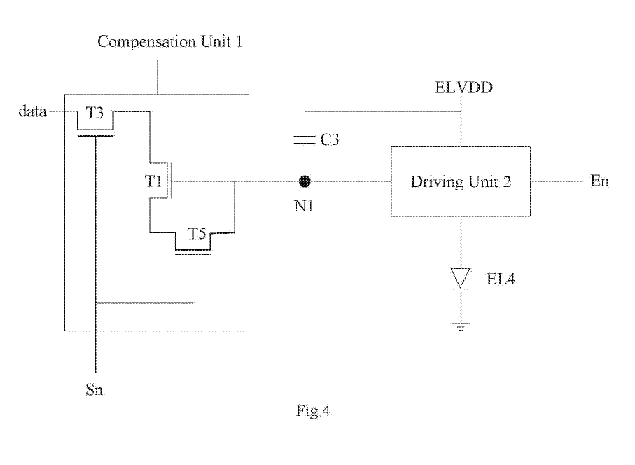

FIG. 3 is a schematic diagram of architecture of a pixel circuit according to an embodiment of the present invention. FIG. 4 is a schematic diagram of another architecture of a pixel circuit according to an embodiment of the present invention. As shown in FIGS. 3 and 4, the pixel circuit includes a compensation unit 1, a driving unit 2, a light emitting unit EL4, a capacitor C3, and an external power supply ELVDD. The compensation unit 1 includes a compensation transistor T1 and a switching transistor T5. In the compensation unit 1, a gate electrode of the switching transistor T5 is connected to a first scanning signal Sn, a first electrode of the switching transistor T5 is electrically connected to a gate electrode of the compensation transistor T1, and a second electrode of the switching transistor T5 is electrically connected to a first electrode of the compensation transistor T1. The gate electrode of the compensation transistor T1 is electrically connected to the driving unit 2 via a first node N1, and a second electrode of the compensation transistor T1 is connected to a data signal data. The external power supply ELVDD, the driving unit 2, and the light emitting unit EL4 are sequentially connected in series, and the capacitor C3 is disposed between the first node N1 and the external power supply ELVDD. When the first scanning signal Sn controls a data strobe transistor T3 to be turned on, and the compensation unit 1 is turned on, the compensation transistor T1 receives the data signal data and sets a voltage of the first node N1 to be a first voltage, i.e., (V_{data}+V_{thT1}), wherein V_{thT1} is a threshold voltage of the compensation transistor T1. The capacitor C3 is configured to keep the voltage at the first node N1 to be the first voltage. A first control signal En is inputted to the driving unit 2 from the external, and when the first control signal En controls the driving unit to be turned on, the driving unit generates a driving current to drive the light emitting unit EL4 to emit light. The driving current is obtained based on the first voltage, the external power supply ELVDD, and a threshold voltage of a driving transistor in the driving unit 2, and when the driving unit 2 is turned on, from Formula 1, it can be seen that an amplitude of a driving current I_{EL4} flowing through the light emitting unit EL4 is as shown in Formula 3:

$${I}_{EL 4} = \frac{1}{2} μ {C}_{OX} \frac{W}{L} {( {V}_{ELVDD} - {V}_{N 1} + {V}_{thT 2} )}^{2} \qquad ( Formula 3 )$$

Wherein V_{ELVDD} is a voltage of the external power supply ELVDD, V_{N1} is a voltage of the first node N1, i.e. a first voltage. V_{thT2} is the threshold voltage of the driving transistor. Since the driving transistor is a common-gate transistor of the compensation transistor T1, the threshold voltage of the driving transistor and the threshold voltage of the compensation transistor T1 have the same variation tendency, i.e., I_{thT1}−V_{thT2}=A, and A is a constant. Thus, Formula 3 can be further transformed into:

$${I}_{EL 4} = \frac{1}{2} μ {C}_{OX} \frac{W}{L} {( {V}_{ELVDD} - {V}_{data} - A )}^{2} \qquad ( Formula 4 )$$

Thus, the influence of a threshold voltage of the driving transistor on a light emitting diode is eliminated. In addition, in the pixel circuit shown in FIGS. 3 and 4, the data signal data is inputted to the data strobe transistor T3 in the compensation unit 1, and the external power supply ELVDD is connected to the driving unit 2, so that the data signal data is written into the first node N1 by the compensation transistor T1 during a data writing stage. In a light emitting stage, the external power supply ELVDD is connected to the driving unit 2, and the data signal data and the external power supply ELVDD are isolated from each other, thereby avoiding the influence of the external power supply ELVDD on the data signal data and improving light emitting stability of a light emitting transistor. In a specific implementation process, an internal structure of the driving unit 2 is not specifically limited in the embodiment of the present invention, and a pixel circuit, in which a function of the driving unit 2 and an interaction relationship between the driving unit 2 and other structures of the pixel circuit in the above embodiment are satisfied, shall be contained in the embodiments of the present invention.

Optionally, the driving transistor and the compensation transistor are a mirror transistor, and both of them have the same threshold voltage, i.e., V_{thT1}=V_{thT2}. At this time, Formula 4 can be further simplified to the relation as shown in Formula 2.

Optionally, the compensation unit 1 may further include a data strobe transistor T3. FIG. 4 is a schematic diagram of another architecture of a pixel circuit according to an embodiment of the present invention. As shown in FIG. 4, a compensation unit 1 includes a data strobe transistor T3, a compensation transistor T1, and a switching transistor T5, wherein a first electrode of the data strobe transistor T3 is electrically connected to a second electrode of the compensation transistor T1, a second electrode of the data strobe transistor T3 is electrically connected to a data signal data, and a gate electrode of the data strobe transistor T3 is electrically connected to a first scanning signal Sn. The data strobe transistor T3 is used to input the data signal data to the compensation transistor T1 under the action of the first scanning signal Sn. The addition of the data strobe transistor T3 in the compensation unit 1 makes the isolation effect between the data signal data and the external power supply ELVDD enhanced, thereby protecting the data signal from being affected by the external power supply ELVDD in a better way.

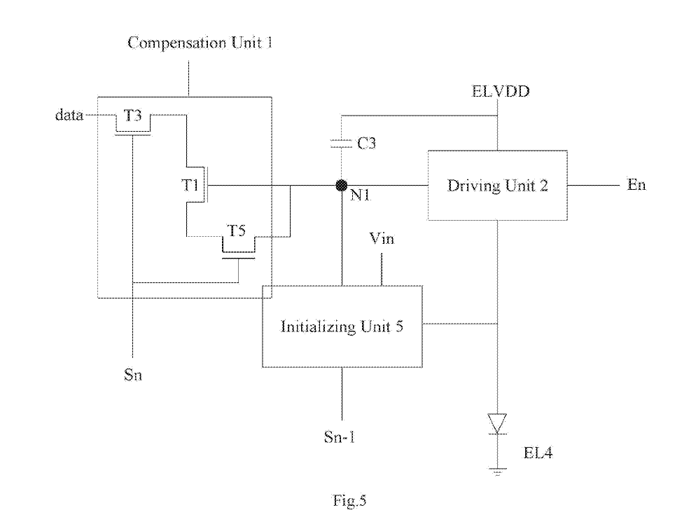

Optionally, the pixel circuit provided by the embodiment of the present invention may further include an initializing unit. FIG. 5 is a schematic diagram of architecture of a pixel circuit having an initializing function according to an embodiment of the present invention. In FIG. 5, an initializing unit 5 is provided between a first node N1 and a light emitting unit EL4, and connected to a second scanning signal Sn−1 and an initializing voltage Vin from the external. When the second scanning signal Sn−1 turns on the initializing unit 5, the initializing unit 5 outputs the initializing voltage to the first node N1 and the light emitting unit EL4, and a capacitor C3 is discharged until a voltage is decreased to Vin, thereby realizing the initializing of the first node N1 and the light emitting unit EL4. A voltage at the first node N1 can be released by the initializing to ensure that a data signal can be written into the node N1 during a next data writing stage. In the embodiment of the present invention, an internal structure of the initializing unit 5 is not specifically limited, and a pixel circuit, in which a function of the initializing unit 5 and an interaction relationship between the initializing unit 5 and a compensation unit 1 and a driving unit 2 in the above embodiment are satisfied, shall be contained in the embodiments of the present invention.

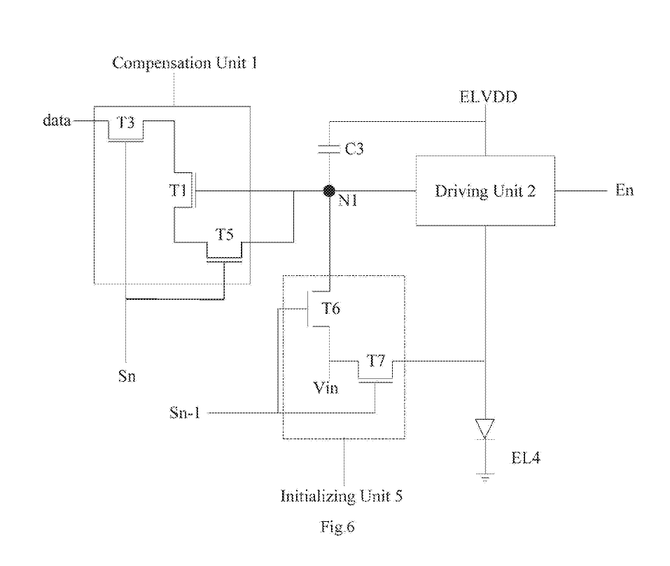

Optionally, an embodiment of the present invention provides a feasible implementation manner of an initializing unit. FIG. 6 is a structural schematic diagram of an initializing unit according to an embodiment of the present invention. In FIG. 6, an initializing unit 5 includes a first initializing transistor T6 and a second initializing transistor T7, a first electrode of the first initializing transistor T6 is externally connected to an initializing voltage Vin, a second electrode of the first initializing transistor T6 is electrically connected to a first node N1, and a gate electrode of the first initializing transistor T6 is electrically connected to a second scanning signal Sn−1. A first electrode of the second initializing transistor T7 is externally connected to the initializing voltage Vin, a second electrode of the second initializing transistor T7 is electrically connected to a light emitting unit EL4, and a gate electrode of the second initializing transistor T7 is electrically connected to the second scanning signal Sn−1. When the second scanning signal Sn−1 turns on the first initializing transistor T6 and the second initializing transistor T7, the initializing voltage is transmitted to the first node N1 through the first initializing transistor T6 to initialize the first node N1, and is transmitted through the second initializing transistor T7 to the light emitting unit EL4 to initialize the light emitting unit EL4. In a specific implementation process, Vin may be an single initializing signal, and may also be the second scanning signal Sn−1. In a case where Vin is the second scanning signal, when the second scanning signal Sn−1 turns on the first initializing transistor T6 and the second initializing transistor T7, the first initializing transistor T6 and the second initializing transistor T7 are in a saturation state, and the second scanning signal is inputted to the first node N1 and an anode of the light emitting unit EL4 respectively through the first initializing transistor T6 and the second initializing transistor T7 until the first initializing transistor T6 and the second initializing transistor T7 are turned off, thereby initializing the first node N1 and the light emitting unit EL4.

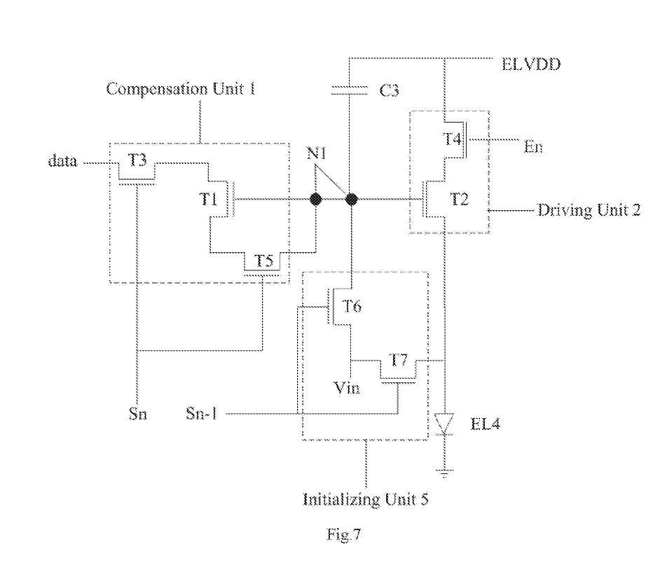

Optionally; an embodiment of the present invention further provides a feasible implementation manner of a driving unit. FIG. 7 is a structural schematic diagram of a driving unit according to an embodiment of the present invention. As shown in FIG. 7, a driving unit 2 includes a driving transistor T2 and a light emitting control transistor T4. A first electrode of the light emitting control transistor T4 is externally connected to an external power supply ELVDD, a second electrode of the light emitting control transistor T4 is electrically connected to a first electrode of the driving transistor T2, and a gate electrode of the light emitting control transistor T4 is externally connected to a first control signal En. A gate electrode of the driving transistor T2 is electrically connected to a compensation transistor T1, and a second electrode of the driving transistor T2 is electrically connected to a light emitting unit EL4. When the first control signal En turns on the light emitting control transistor T4, the external power supply ELVDD is connected with the first electrode of the driving transistor T2 via the light emitting control transistor T4. The driving transistor T2 generates a driving current according to a voltage of the gate electrode and the external power supply ELVDD, and the driving current is inputted to the light emitting unit EL4 through the light emitting control transistor to drive the light emitting unit EL4 to emit light.

In summary, the embodiments of the present invention provide a pixel circuit including a compensation unit, a driving unit, a light emitting unit, a capacitor, and an external power supply, wherein the compensation unit includes a compensation transistor and a switching transistor; in the compensation unit, a gate electrode of the switching transistor is connected to a first scanning signal, a first electrode of the switching transistor is electrically connected to a gate electrode of the compensation transistor, and a second electrode of the switching transistor is electrically connected to a first electrode of the compensation transistor; the gate electrode of the compensation transistor is electrically connected to the driving unit through a first node, and a second electrode of the compensation transistor is connected to a data signal; the external power supply, the driving unit, and the light emitting unit are connected in series in sequence; the capacitor is disposed between the first node and the external power supply; the compensation unit is configured to turn on the switching transistor under the control of the first scanning signal, so that the compensation transistor sets a voltage of the first node to be a first voltage, wherein the first voltage is a voltage obtained by compensating a voltage of the data signal by the compensation transistor; the capacitor is configured to keep the voltage of the first node to be the first voltage; a first control signal is inputted to the driving unit from the external, and the driving unit is configured to generate a driving current to drive a light emitting unit to emit light according to the first control signal, wherein the driving current is obtained based on the first voltage, the external power supply and a threshold voltage of a driving transistor in the driving unit; and the driving transistor and the compensation transistor are a common-gate transistor. The data signal is inputted to the compensation unit from the external, and the driving unit is externally connected to the external power supply, so that in a data writing stage, the data signal is compensated by the compensation transistor in the compensation unit, and a threshold voltage of the compensation transistor compensates the voltage of the data signal to obtain the first voltage. Since the compensation unit is not externally connected to the external power supply, the influence of the external power supply on the data signal is avoided. Moreover, the driving transistor and the compensation transistor are a common-gate transistor, both of them having the same change trend of threshold voltage, so compensating the threshold voltage of the compensation transistor to the voltage of the data signal corresponds to compensating the threshold voltage of the driving transistor to the voltage of the data signal, which ensures a threshold compensation function of the pixel circuit. Therefore, the embodiments of the present invention can achieve the threshold compensation function of the pixel circuit while avoiding the influence of the external power supply on the data signal, thereby improving light-emitting stability of a light-emitting diode. In addition, the switching transistor in the compensation unit can not only control the turn-on and turn-off of the compensation unit, but also can indirectly control the input of the data signal, in this way, one transistor achieves functions of two transistors, thereby simplifying a circuit structure and reducing circuit costs.

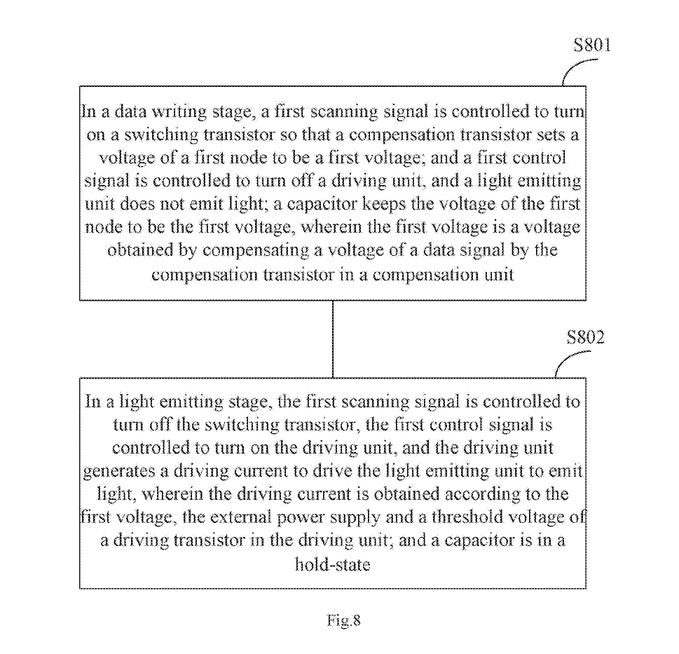

Based on the same technical idea, an embodiment of the present invention further provides a method for driving a pixel circuit, which is used for driving the pixel circuit provided by the embodiments of the present invention. FIG. 8 is a schematic flowchart of a method for driving a pixel circuit according to an embodiment of the present invention. As shown in FIG. 8, the method includes:

S801: a data writing stage, in which a first scanning signal is controlled to turn on a switching transistor so that a compensation transistor sets a voltage of a first node to be a first voltage; and a first control signal is controlled to turn off a driving unit, and a light emitting unit does not emit light; and a capacitor keeps the voltage of the first node to be the first voltage, wherein the first voltage is a voltage obtained by compensating a voltage of a data signal by the compensation transistor in a compensation unit;

S802: a light emitting stage, the first scanning signal is controlled to turn off the switching transistor, and the first control signal is controlled to turn on the driving unit, the driving unit generates a driving current to drive the light emitting unit to emit light, where the driving current is obtained according to the first voltage, the external power supply and a threshold voltage of a driving transistor in the driving unit; and a capacitor is in a hold-state.

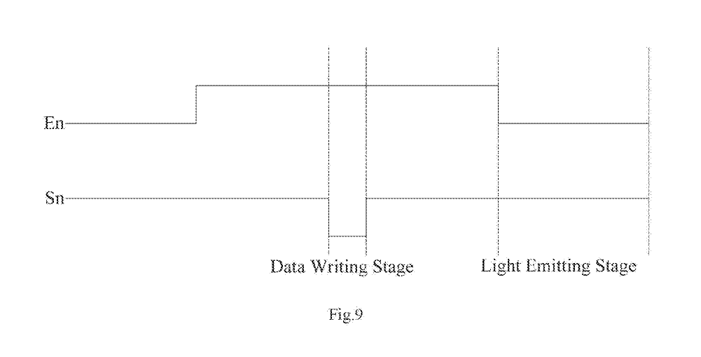

During specific implementation, the above-described embodiment can drive the pixel circuit as shown in FIG. 3. Optionally, the compensation unit 1 and the driving unit 2 are turned on or off by controlling the turn-on of the switching transistor T5 in the compensation unit 1 and the transistor in the driving unit 2. At this time, the pixel circuit shown in FIG. 3 corresponds to a driving signal as shown in FIG. 9. FIG. 9 is a schematic diagram of a driving signal provided by an embodiment of the present invention. The driving signal in FIG. 9 includes a first scanning signal Sn and a first control signal En, and timings of the first scanning signal Sn and the first control signal En when the transistors of the compensation unit 1 and the driving unit 2 in the circuit as shown in FIG. 3 are PMOS (Positive channel Metal Oxide Semiconductor) transistors.

In a data writing stage, as shown in FIG. 9, a first scanning signal Sn is at a low level and a switching transistor T5 is turned on so that a compensation unit 1 is turned on, a first control signal En is at a high level, and a driving unit 2 is turned off. A compensation transistor T1 writes a data signal data into a first node N1, and a capacitor C3 starts charging until a voltage of the first node N1 is set to a first voltage (V_{data}+V_{thT1}). Afterwards, the compensation transistor T1 in the compensation unit 1 is turned off, and the capacitor C3 keeps the voltage of the first node N1 to be the first voltage (V_{data}+V_{thT1}).

In a light emitting stage, as shown in FIG. 9, the first scanning signal Sn is at a high level, the switching transistor T5 is turned off, the compensation unit 1 is turned off, the first control signal En is at a low level, and the driving unit 2 is turned on. The driving unit 2 generates a driving current to drive a light emitting unit EL4 to emit light. Since the voltage of the first node N1 is the first voltage (V_{data}+V_{thT1}), a voltage of a gate electrode of a driving transistor in the driving unit 2 can be threshold-compensated so that the driving current is no longer affected by a threshold drift of the driving transistor.

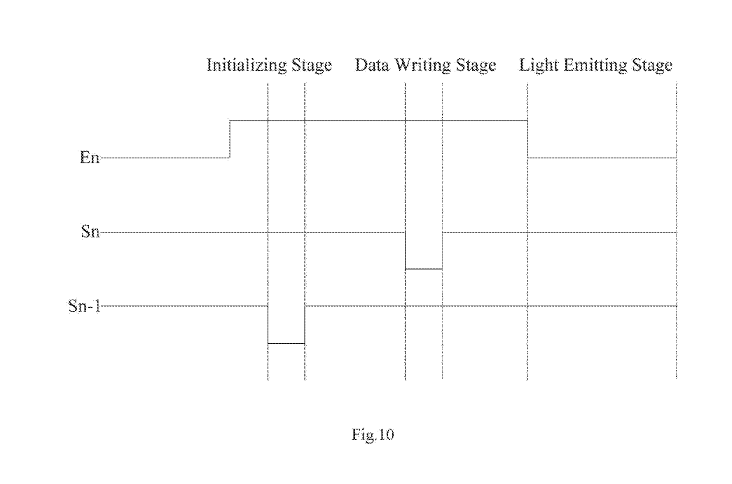

Corresponding to the pixel circuit shown in FIG. 5, an embodiment of the present invention further provides a method for driving another pixel circuit. FIG. 10 is a schematic diagram of a driving signal according to an embodiment of the present invention. As shown in FIG. 10, the driving signal includes a first scanning signal Sn, a second scanning signal Sn−1, and a first control signal En. In addition, timings of the first scanning signal Sn, the second scanning signal Sn−1, and the first control signal En when the transistors of the compensation unit 1, the driving unit 2, and the initializing unit 5 in the circuit as shown in FIG. 5 are PMOS transistors are also disclosed, and before a data writing stage, the method should further include an initializing stage, which are described specifically as follows:

In an initializing stage, the second scanning signal Sn−1 is controlled to turn on the initializing unit 5, the initializing unit 5 initializes the first node N1 and the light emitting unit EL4 with an initializing voltage Vin, the capacitor C3 holds the initializing voltage Vin, and the first scanning signal Sn is controlled in such a manner that the data strobe transistor T3 and the switching transistor T5 are turned off, thereby turning off the compensation unit 1, and the first control signal En is controlled to turn off the driving unit 2.

In the data writing stage, as shown in FIG. 10, the first scanning signal Sn is at a low level, the data strobe transistor T3 and the switching transistor T5, and the compensation unit 1 are turned on; the first control signal En is at a high level, the driving unit 2 is turned off; and the second scanning signal Sn−1 is at a high level, and the initializing unit 5 is turned off. The compensation transistor T1 writes the data signal data into the first node N1, and the capacitor C3 starts charging until the voltage of the first node N1 is set to the first voltage (V_{data}+V_{thT1}). Subsequently, the compensation transistor T1 is turned off, and the capacitor C3 keeps the voltage of the first node N1 to be the first voltage (V_{data}+V_{thT1}).

In a light emitting stage, as shown in FIG. 10, the first scanning signal Sn is at a high level, the data strobe transistor T3 and the switching transistor T5 are turned off, and the compensation unit 1 is turned off; the second scanning signal Sn−1 is at a high level, the initializing unit is turned off, and the first control signal En is at a low level, and the driving unit 2 is turned on. The driving unit 2 generates a driving current to drive the light emitting unit EL4 to emit light. Since the voltage of the first node is the first voltage (V_{data}+V_{thT1}), which can threshold-compensates a voltage of the gate electrode of the driving transistor in the driving unit 2, so that the driving current is no longer affected by a threshold drift of the driving transistor.

In order to solve the problem in the prior art that a light emitting diode in a pixel circuit fails to emit light stably and has a complicated structure, the embodiments of the present invention make further optimization on the basis of a conventional threshold compensation circuit to avoid the influence of the external power supply on the data signal and enable the light emitting diode to emit light more stably, in this way, functions of two transistors are implemented by one switching transistor, which simplifies the circuit. Several specific implementation manners are introduced hereinafter by taking PMOS as an example. It should be pointed out that modifications of the following specific embodiments, for example, modified NMOS or COMS circuits and a method for driving the same should also fall into the protection scope of the embodiments of the present invention. The present application will not elaborate all of the transformed pixel circuits, and only some of the pixel circuits are introduced to explain the technical solutions disclosed in the embodiments of the present invention.

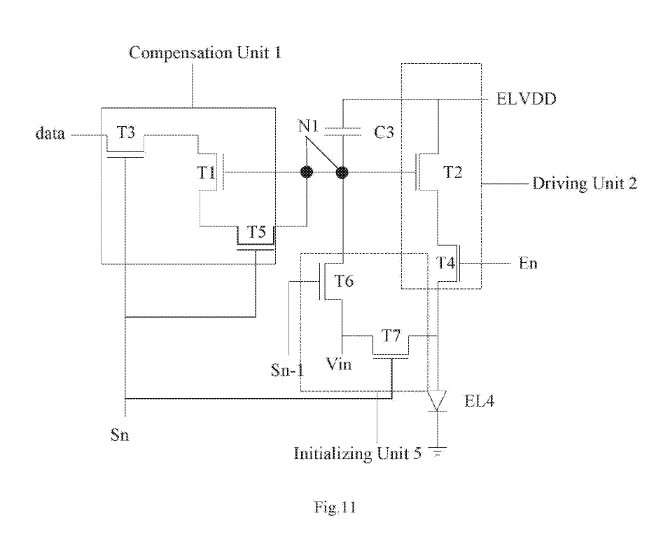

FIG. 11 shows one of possible implementation manners of a pixel circuit according to an embodiment of the present invention. As shown in FIG. 11, a compensation unit includes a data strobe transistor T3, a compensation transistor T1 and a switching transistor T5, a driving unit includes a driving transistor T2 and a light emitting control transistor T4, and an initializing unit includes a first initializing transistor T6 and a second initializing transistor T7.

In the compensation unit 1, a drain electrode of the data strobe transistor T3 is electrically connected to a source electrode of the compensation transistor T1, a source electrode of the data strobe transistor T3 is electrically connected to a data signal data, and a gate electrode of the data strobe transistor T3 is electrically connected to a first scanning signal Sn; a gate electrode of the compensation transistor T1 is electrically connected to a gate electrode of the driving transistor T2 through a first node N1, and a drain electrode of the compensation transistor T1 is electrically connected to a source electrode of the switching transistor T5. A drain electrode of the switching transistor T5 is electrically connected to the gate electrode of the compensation transistor T1, and a gate electrode of the switching transistor T5 is electrically connected to the first scanning signal Sn.

In the driving unit 2, a source electrode of the driving transistor T2 is externally connected to an external power supply ELVDD, and a drain electrode of the driving transistor T2 is electrically connected to a source electrode of the light emitting control transistor T4; a drain electrode of the light emitting control transistor T4 is electrically connected to a light emitting unit EL4, and a gate electrode of the light emitting control transistor T4 is externally connected to a first control signal En.

In the initializing unit 5, a source electrode of the first initializing transistor T6 is externally connected to an initializing voltage Vin, a drain electrode of the first initializing transistor T6 is electrically connected to the first node N1, and a gate electrode of the first initializing transistor T6 is electrically connected to a second scanning signal Sn−1; a source electrode of the second initializing transistor T7 is externally connected to the initializing voltage Vin, a drain electrode of the second initializing transistor T7 is electrically connected to the light emitting unit EL4; different from the pixel circuits shown in FIGS. 6 and 7, a gate electrode of the second initializing transistor T7 is electrically connected to the first scanning signal Sn, so that the first initializing transistor T6 and the second initializing transistor T7 can perform initializing in different time periods to prevent an excessively large instantaneous current caused by the initializing voltage Vin, to burn out the pixel circuit or a power source circuit that supplies power for the pixel circuit.

A capacitor C3 is disposed between the first node N1 and the external power supply ELVDD.

According to the driving signal as shown in FIG. 10, the method for driving the pixel circuit shown in FIG. 11 is as follows:

In an initializing stage, the first scanning signal Sn is at a high level, the data strobe transistor T3 and the switching transistor T5 are turned off, the compensation unit 1 is turned off, and the second initializing transistor T7 is turned off. The first control signal En is at a high level, the light emitting control transistor T4 is turned off and the driving unit 2 is turned off. The second control signal Sn−1 is at a low level, the first initializing transistor T6 is turned on, and the first initializing transistor T6 transfers the initializing voltage to the first node N1 to initialize the first node N1.

In a data writing stage, the first scanning signal Sn is at a low level, the data strobe transistor T3 and the switching transistor T5 are turned on, and the compensation unit 1 is turned on. The first control signal En is at a high level, the light emitting control transistor T4 is turned off and the driving unit 2 is turned off. The second scanning signal Sn−1 is at a high level, the first initializing transistor T6 is turned off and the initializing unit 5 is turned off. The data signal data reaches the source electrode of the compensation transistor T1 via the data strobe transistor T3. Since the drain electrode and the gate electrode of the compensation transistor are short-circuited, the compensation transistor T1 operates in a saturation region, and the data signal data is written into the first node N1 until the voltage of the first node N1 reaches the first voltage (V_{data}+V_{thT1}), then the compensation transistor T1 is turned off. Since the first scanning signal Sn is at a low level, the second initializing transistor T7 is turned on, and the second initializing transistor T7 transfers the initializing voltage Vin to the light emitting unit EL4, thereby initializing the light emitting unit EL4.

In a light emitting stage, the first scanning signal Sn is at a high level, the data strobe transistor T3 and the switching transistor T5 are turned off, the compensation unit 1 is turned off, and the second initializing transistor T7 is turned off. The first control signal En is at a low level, the light emitting control transistor T4 is turned on and the driving unit 2 is turned on. The second scanning signal Sn−1 is at a high level, the first initializing transistor T6 is turned off and the initializing unit 5 is turned off. The driving transistor T2 generates a driving current to drive the light emitting unit EL4 to emit light. Since the voltage of the first node is the first voltage (V_{data}+V_{thT1}), which can threshold-compensates a voltage of the gate electrode of the driving transistor, so that the driving current is no longer affected by a threshold drift of the driving transistor T2.

### Second Embodiment

An embodiment of the present invention further provides a method for driving the pixel circuit shown in FIG. 7. According to the driving signal shown in FIG. 10, the method for driving the pixel circuit shown in FIG. 7 is as follows:

In an initializing stage, the first scanning signal Sn is at a high level, the data strobe transistor T3 and the switching transistor T5 are turned off, and the compensation unit 1 is turned off. The first control signal En is at a high level, the light emitting control transistor T4 is turned off, and the driving unit 2 is turned off. The second control signal Sn−1 is at a low level, the first initializing transistor T6 and the second initializing transistor T7 are turned on, the first initializing transistor T6 transfers the initializing voltage to the first node N1 to initialize the first node N1, and the second initializing transistor T7 transfers the initializing voltage Vin to the light emitting unit EL4 to initialize the light emitting unit EL4.

In a data writing stage, the first scanning signal Sn is at a low level, the data strobe transistor T3 and the switching transistor T5 are turned on, and the compensation unit 1 is turned on. The first control signal En is at a high level, the light emitting control transistor T4 is turned off, and the driving unit 2 is turned off. The second scanning signal Sn−1 is at a high level, the first initializing transistor T6 and the second initializing transistor T7 are turned off, and the initializing unit 5 is turned off. The data signal data reaches the source electrode of the compensation transistor T1 via the data strobe transistor T3. Since the drain electrode and the gate electrode of the compensation transistor T1 are short-circuited, the compensation transistor T1 operates in a saturation region, and the data signal data is written into the first node N1 until the voltage of the first node N1 reaches the first voltage (V_{data}+V_{thT1}), then the compensation transistor T1 is turned off.

In a light emitting stage, the first scanning signal Sn is at a high level, the data strobe transistor T3 and the switching transistor T5 are turned off, and the compensation unit 1 is turned off. The first control signal En is at a low level, the light emitting control transistor T4 is turned on, and the driving unit 2 is turned on. The second scanning signal Sn−1 is at a high level, the first initializing transistor T6 and the second initializing transistor T7 are turned off, and the initializing unit 5 is turned off. The driving transistor T2 generates a driving current to drive the light emitting unit EL4 to emit light. Since the voltage of the first node N1 is the first voltage (V_{data}+V_{thT1}), which can threshold-compensates a voltage of the gate electrode of the driving transistor, so that the driving current is no longer affected by a threshold drift of the driving transistor T2.

In the foregoing first and second embodiments, optionally, the first initializing transistor T6 and the second initializing transistor T7 in the initializing unit 5 may also adopt the following connection manners; the first electrode of the first initializing transistor T6 is electrically connected to the first node N1, the gate electrode of the first initializing transistor T6 is externally connected to the second scanning signal Sn−1, the second electrode of the first initializing transistor T6 is electrically connected to the light emitting unit EL4, the first electrode of the second initializing transistor T7 is electrically connected to the light emitting unit EL4, the second electrode of the second initializing transistor T7 is externally connected to the initializing voltage Vin, the gate electrode of the second initializing transistor T7 is externally connected to the second scanning signal Sn−1, and the first initializing transistor T6 and the second initializing transistor T7 are a dual-gate transistor. The use of a double-gate transistor to replace the original transistors T6 and T7 reduces the number of transistors in the pixel circuit, thereby simplifying the circuit.

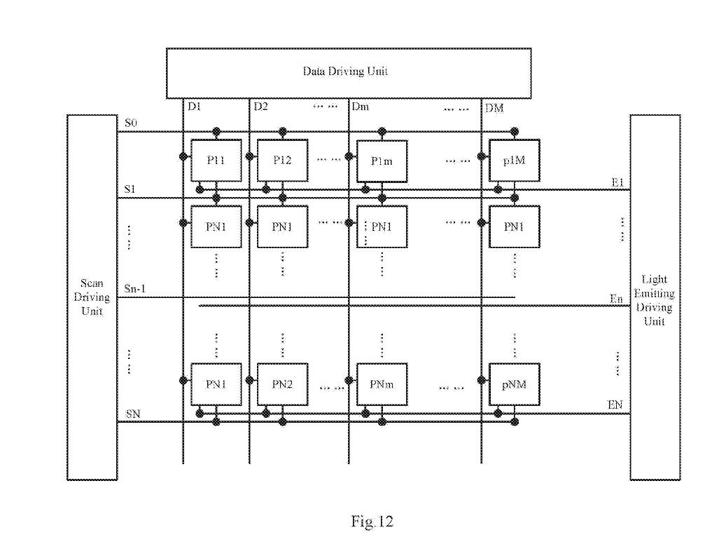

Based on the same technical idea, an embodiment of the present invention further provides a display employing the pixel circuit provided by any one of the above-described embodiments. FIG. 12 is a structural schematic diagram of a display provided by an embodiment of the present invention. In FIG. 12, the display includes an N×M pixel circuit array. A scan driving unit generates scanning signals S0, S1, S2, . . . SN, and Sn is a scanning signal for pixels in the n^{th} row inputted by the scan driving unit, n=1, 2, . . . N. A data driving unit generates a data signal data including a total of M data signals D1, D2, . . . DM corresponding to M columns of pixels, respectively, and Dm is a data signal data for pixels in the m^{th} column, m=1, 2, . . . M. A light emitting driving unit generates first control signals E1, E2, . . . EN, and En is a first control signal for the pixels in the n^{th} row inputted by the light emitting driving unit, n=1, 2, . . . N.

In summary, the embodiments of the present invention provide a pixel circuit, a driving method thereof, and a display using the same, and the pixel circuit includes a compensation unit, a driving unit, a light emitting unit, a capacitor and an external power supply, wherein the compensation unit includes a compensation transistor and a switching transistor; in the compensation unit, a gate electrode of the switching transistor is connected to a first scanning signal, a first electrode of the switching transistor is electrically connected to a gate electrode of the compensation transistor, and a second electrode of the switching transistor is electrically connected to a first electrode of the compensation transistor; the gate electrode of the compensation transistor is electrically connected to the driving unit through a first node, and a second electrode of the compensation transistor is connected to a data signal; the external power supply, the driving unit, and the light emitting unit are connected in series in sequence; the capacitor is disposed between the first node and the external power supply; the compensation unit is configured to turn on the switching transistor under the control of the first scanning signal, so that the compensation transistor sets a voltage of the first node to be a first voltage, wherein the first voltage is a voltage obtained by compensating a voltage of the data signal by the compensation transistor; the capacitor is configured to keep the voltage of the first node to be the first voltage; a first control signal is inputted to the driving unit from the external, and the driving unit is configured to generate a driving current to drive a light emitting unit to emit light according to the first control signal, wherein the driving current is obtained based on the first voltage, the external power supply and a threshold voltage of a driving transistor in the driving unit, and the driving transistor and the compensation transistor are a common-gate transistor. The data signal is inputted to the compensation unit from the external, and the driving unit is externally connected to the external power supply, so that in a data writing stage, the data signal is compensated by the compensation transistor in the compensation unit, and a threshold voltage of the compensation transistor compensates the voltage of the data signal to obtain the first voltage. Since the compensation unit is not externally connected to the external power supply, the influence of the external power supply on the data signal is avoided. Moreover, the driving transistor and the compensation transistor are a common-gate transistor, both of them having the same threshold voltage, so compensating the threshold voltage of the compensation transistor to the voltage of the data signal corresponds to compensating the threshold voltage of the driving transistor to the voltage of the data signal, which ensures a threshold compensation function of the pixel circuit. Therefore, the embodiments of the present invention can achieve the threshold compensation function of the pixel circuit while avoiding the influence of the external power supply on the data signal, thereby improving light-emitting stability of a light-emitting diode. In addition, the switching transistor in the compensation unit can not only control the turn-on and turn-off of the compensation unit, but also can indirectly control the input of the data signal, in this way, one transistor achieves functions of two transistors, thereby simplifying a circuit structure and reducing circuit costs.

Although the preferred embodiments of the present invention have been described, those skilled in the art can make additional changes and modifications to these embodiments once they learn the basic inventive concept. Therefore, the appended claims are intended to be interpreted as including the preferred embodiments and all changes and modifications that fall within the scope of the present invention.

It will be apparent to those skilled in the art that various modifications and variations can be made in the present invention without departing from the spirit and scope of the invention. Thus, if these modifications and variations of the present invention fall within the scope of the claims of the present invention and their equivalents, the present invention is also intended to include these modifications and variations.

What is claimed is:

1. A pixel circuit, comprising: a compensation unit, a driving unit, a light emitting unit, a capacitor and an external power supply, wherein the compensation unit comprises a compensation transistor and a switching transistor;
in the compensation unit, a gate electrode of the switching transistor is connected to a first scanning signal, a first electrode of the switching transistor is electrically connected to a gate electrode of the compensation transistor, and a second electrode of the switching transistor is electrically connected to a first electrode of the compensation transistor; the gate electrode of the compensation transistor is electrically connected to the driving unit through a first node, and a second electrode of the compensation transistor is connected to a data signal; the external power supply, the driving unit, and the light emitting unit are connected in series in sequence; and the capacitor is disposed between the first node and the external power supply;
the compensation unit is configured to turn on the switching transistor under the control of the first scanning signal, so that the compensation transistor sets a voltage of the first node to be a first voltage, which is a voltage obtained by compensating a voltage of the data signal by the compensation transistor;
the capacitor is configured to keep the voltage of the first node to be the first voltage; and
a first control signal is inputted to the driving unit from the external, and the driving unit is configured to generate a driving current to drive the light emitting unit to emit light according to the first control signal, wherein the driving current is obtained based on the first voltage, the external power supply and a threshold voltage of a driving transistor in the driving unit; and the driving transistor and the compensation transistor are a common-gate transistor.

2. The pixel circuit according to claim 1, wherein the driving transistor and the compensation transistor are a mirror transistor.

3. The pixel circuit according to claim 1, wherein the compensation unit further includes a data strobe transistor,
wherein a first electrode of the data strobe transistor is electrically connected to the second electrode of the compensation transistor, a second electrode of the data strobe transistor is electrically connected to the data signal, and a gate electrode of the data strobe transistor is electrically connected to the first scanning signal, and the data strobe transistor is configured to input the data signal to the compensation transistor under the effect of the first scanning signal.

4. The pixel circuit according to claim 1, further comprising: an initializing unit,
wherein the initializing unit is disposed between the first node and the light emitting unit, and a second scanning signal and an initializing voltage are inputted to the initializing unit from the external; and
the initializing unit is configured to initialize the first node and the light emitting unit with the initializing voltage under the control of the second scanning signal.

5. The pixel circuit according to claim 4, wherein the initializing unit comprises a first initializing transistor and a second initializing transistor,
wherein the initializing voltage is inputted to a first electrode of the first initializing transistor from the external, a second electrode of the first initializing transistor is electrically connected to the first node, and a gate electrode of the first initializing transistor is electrically connected to the second scanning signal, and
the initializing voltage is inputted to a first electrode of the second initializing transistor from the external, a second electrode of the second initializing transistor is electrically connected to the light emitting unit, and a gate electrode of the second initializing transistor is electrically connected to the second scanning signal.

6. A method for driving a pixel circuit, applied to a pixel circuit according to claim 1, comprising:
a data writing stage, in which the first scanning signal is controlled to turn on the switching transistor so that the compensation transistor sets a voltage of the first node to be the first voltage; the first control signal is controlled to turn off the driving unit, and the light emitting unit does not emit light; the capacitor keeps the voltage of the first node to be the first voltage, wherein the first voltage is a voltage obtained by compensating a voltage of the data signal by the compensation transistor in the compensation unit; and
a light emitting stage, the first scanning signal is controlled to turn off the switching transistor, and the first control signal is controlled to turn on the driving unit, and the driving unit generates a driving current to drive the light emitting unit to emit light, wherein the driving current is obtained based on the first voltage, the external power supply and a threshold voltage of the driving transistor in the driving unit; and the capacitor is in a hold-state.

7. The method according to claim 6, wherein the pixel circuit is further according to claim 3, and the data writing stage further comprises:
controlling the first scanning signal to turn on the data strobe transistor to input the data signal to the compensation transistor.

8. The method according to claim 6, wherein the pixel circuit is further according to claim 4, and before the data writing stage, the method further comprises:
an initializing stage, in which the second scanning signal is controlled to turn on the initializing unit, which initializes the first node and the light emitting unit using the initializing voltage, the capacitor holds the initializing voltage, the first scanning signal is controlled to turn off the switching transistor, and the first control signal is controlled to turn off the driving unit.

9. The method according to claim 8, wherein
the data writing stage further comprises controlling the second scanning signal to turn off the initializing unit, and
the lighting emitting stage further comprises controlling the second scanning signal to turn off the initializing unit.

10. A display comprising the pixel circuit according to claim 1.

11. The display according to claim 10, wherein the pixel circuit is further according to claim 2.

12. The display according to claim 10, wherein the pixel circuit is further according to claim 3.

13. The display according to claim 10, wherein the pixel circuit is further according to claim 4.

14. The display according to claim 10, wherein the pixel circuit is further according to claim 5.
